(19) United States
(12) Patent Application Publication
(10) Pub. No.: US 2011/0252068 A1
(43) Pub. Date: Oct. 13, 2011

(54) CREATING EDIT SCRIPTS FOR CONVERSION OF DATA TABLES

(75) Inventor: Hamish Andrew Smith, Lyttelton (NZ)

(73) Assignee: TAIT ELECTRONICS LIMITED, Christchurch (NZ)

(21) Appl. No.: 13/082,767

(22) Filed: Apr. 8, 2011

Related U.S. Application Data
(60) Provisional application No. 61/323,437, filed on Apr. 13, 2010.

(30) Foreign Application Priority Data
Apr. 9, 2010 (NZ) NZ 584534

(51) Int. Cl. G06F 17/30

(52) U.S. Cl. 707/797; 707/803; 707/E17.005; 707/E17.012

(57) ABSTRACT

Embodiments of the invention assist conversion of an old data table to a new data table in a communication terminal. An edit script is created by creating an old and new data trees from the old and new tables respectively. A first partial script which converts the old tree to an intermediate tree having the same length as the new tree is then determined. A second partial script which converts the intermediate tree to the new tree is also determined. The first and second partial scripts are then combined to provide a script which can be sent the terminal. The first partial script is preferably a minimum cost series of edits causing only insertions and deletions in the old data tree. The second partial script is preferably a minimum cost series of edits causing only substitutions in the intermediate tree.

### RELATED APPLICATIONS

This application claims the benefit of U.S. Provisional Patent Application No. 61/323,437, filed Apr. 13, 2010 and New Zealand Patent Application No. NZ 584534, filed Apr. 9, 2010, both of which are incorporated by reference herein in their entirety.

### BACKGROUND

This invention relates to methods for conversion of data tables in communication terminals, in particular but not only to methods for creating edit scripts which can be used when updating data in mobile radios.

Over the air programming (OTAP) has been developed so that mobile terminals in a radio network can be re-programmed with new software or data without requiring the terminals to be returned to a central management site. The data held in a mobile terminal is usually stored in a tabular format which can be updated in various ways, typically by sending an entirely new table which replaces the old table, or by sending an edit script or difference file which converts the old table to create the new table.

Systems involving edit scripts are described in U.S. Pat. No. 5,832,520 and U.S. Pat. No. 7,003,534 for example. Creating an edit script typically involves determining differences between the old table and the new table and creating a relatively short piece of code containing operations such as insert, delete and relabel. The script is then broadcast over the air from the central site to each terminal which requires an update. Several different edit scripts may be required where different groups of terminals contain different tables or the same tables with different data. For the process to be efficient, the time taken to create, broadcast and carry out the edit script should be less than the time taken to simply broadcast the new data.

There are a number of existing algorithms for determining the differences between two files, such as standard text differencing algorithms and binary differencing algorithms. Other algorithms for converting one sequence of symbols into another, involving calculation of path lengths in an edit graph or edit distance matrix have also been developed, as described by Eugene Myers, entitled “An O(ND) Difference Algorithm and its Variations”, Algorithmica, vol 1, p 251-266 (1986). These are relatively inefficient when the data is available in a hierarchical form such as a table or tree. More efficient algorithms have therefore been developed to find minimum cost edit scripts when the old and new data are represented as rooted, ordered, labelled trees, as described by Sudarshan Chawathe, entitled “Comparing Hierarchical Data in External Memory”, VLDB'99, Proceedings of 25^{th} International Conference on Very Large Databases, Sep. 7-10, 1999, p 90-101 (Morgan Kaufmann, 1999). A recent tree based system is described in U.S. Pat. No. 7,287,026 for example.

An edit distance matrix can be formed from two suitably constructed trees. The two axes of the matrix are typically formed by nodes of the tree which contain data values. The matrix may then be used to determine an edit path between the trees. The path is determined by a directed graph which joins vertices in the matrix using insert, delete or relabel operations. An edit path can be used to recover an edit script for conversion of one tree into the other. Various algorithms are known for optimising or at least reducing the length and other processing costs of the edit paths.

### SUMMARY OF THE DESCRIPTION

It is therefore an object of the invention to provide improved methods for conversion of data tables, or at least to provide a useful alternative to existing methods. Embodiments of the invention assist conversion of an old data table to a new data table in a communication terminal. An edit script is created by creating an old and new data trees from the old and new tables respectively. A first partial script which converts the old tree to an intermediate tree having the same length as the new tree is then determined. A second partial script which converts the intermediate tree to the new tree is also determined. The first and second partial scripts are then combined to provide a script which can be sent the terminal. The first partial script is preferably a minimum cost series of edits causing only insertions and deletions in the old data tree. The second partial script is preferably a minimum cost series of edits causing only substitutions in the intermediate tree.

### BRIEF DESCRIPTION OF THE DRAWINGS

Embodiments of the invention will be described with respect to the accompanying drawings, of which:

FIG. 1 schematically shows data tables used by radio units in a radio network,

FIG. 2 shows a routine for creation of edit scripts for conversion of multiple data tables in a database,

FIG. 3A/3B shows a routine for creating an edit script for an individual table,

FIG. 4A/4B shows a routine for calculating an edit distance between an old tree and a new tree,

FIG. 5 shows a routine for converting a table to a row major tree,

FIG. 6 shows a routine for converting a row major tree to a column major tree,

FIG. 7 shows a routine for creating a partial edit script,

FIG. 8 shows a routine for converting an old tree into an intermediate tree having the same length,

FIG. 9 shows a routine for creating an edit script for converting the old tree into the intermediate tree,

FIG. 10 shows a routine for creating an edit script from a directed graph,

FIGS. 11A, 11B are simple examples of an old table and a new table,

FIGS. 12A, 12B are examples of an old tree and a new tree corresponding to FIGS. 11A, 11B,

FIG. 13 is an edit distance matrix for the old and new trees in FIGS. 11A, 11B,

FIG. 14 shows allowed routes through the matrix in FIG. 13,

FIG. 15 shows update, insert, delete steps to a vertex in an edit distance matrix,

FIGS. 16A, 16B, 16C show routines for costing the update, insert, delete steps in FIG. 15,

FIGS. 17A to 17F show costing steps for edit paths in the matrix of FIG. 14,

FIG. 18 shows the optimal edit path for FIG. 14,

FIG. 19A, 19B show two forms of an edit script recovered from FIG. 18,

FIGS. 20A, 20B show the intermediate tree for FIG. 14 in row major and column major forms,

FIG. 21 shows the new tree for FIG. 14 in column major form,

FIGS. 22A, 22B show the edit distance matrices corresponding to FIGS. 20A, 20B and FIG. 21, and the optimal edit pathways,

FIG. 23 shows an edit script recovered from FIG. 20B, and

FIG. 24 shows an edit script formed by combining the scripts in FIGS. 19B and 23.

### DETAILED DESCRIPTION

Referring to the drawings it will be appreciated that embodiments of the invention can be implemented in a range of different ways for a variety of mobile radio systems, and potentially other unrelated systems, which use and update data in hierarchical forms. The embodiments described here are given by way of example only. Many details of conventional radio systems have been omitted for clarity but will also be appreciated by a skilled reader.

In one aspect the invention may be said to reside in a method of creating an edit script for conversion of an old data table to a new data table, including: creating an old data tree and a new data tree from the old table and the new table respectively, determining a first partial script which converts the old tree to an intermediate tree having the same length as the new tree, determining a second partial script which converts the intermediate tree to the new tree, and combining the first and second partial scripts.

Preferably the first partial script is determined as a minimum cost series of edits causing only insertions and deletions in the old data tree. Only complete sub-trees are inserted or deleted in the old data tree. Preferably the second partial script is determined as a minimum cost series of edits causing only substitutions in the intermediate tree.

Preferably the first partial script is determined using an edit distance matrix with the old tree and the intermediate tree in row major form. The second partial script may be determined using an edit distance matrix with the intermediate tree and the new tree in row major form. Alternatively the second partial script is determined using an edit distance matrix with the intermediate tree and the new tree in column major form.

Preferably the method further includes: determining a secondary script which converts the intermediate tree to the new tree using row major forms, determining a secondary script which converts the intermediate tree to the new tree using column major forms, selecting the second partial script from the secondary scripts based on cost.

Preferably the data trees are rooted, ordered, labelled trees formed from data in a respective table. The data trees also preferably contain only nodes having a degree of 0, 1, 2 and only nodes of degree 2 contain data from the respective table.

In a further aspect the invention may be said to reside in a method of updating data in a mobile communication device, including: determining an old data table which exists in the device, determining a new data table which is required in the device, determining an edit script which converts the old data table to the new data table, transmitting the edit script to the device, and actuating the device to implement the edit script, wherein the edit script is determined using a method as outlined above.

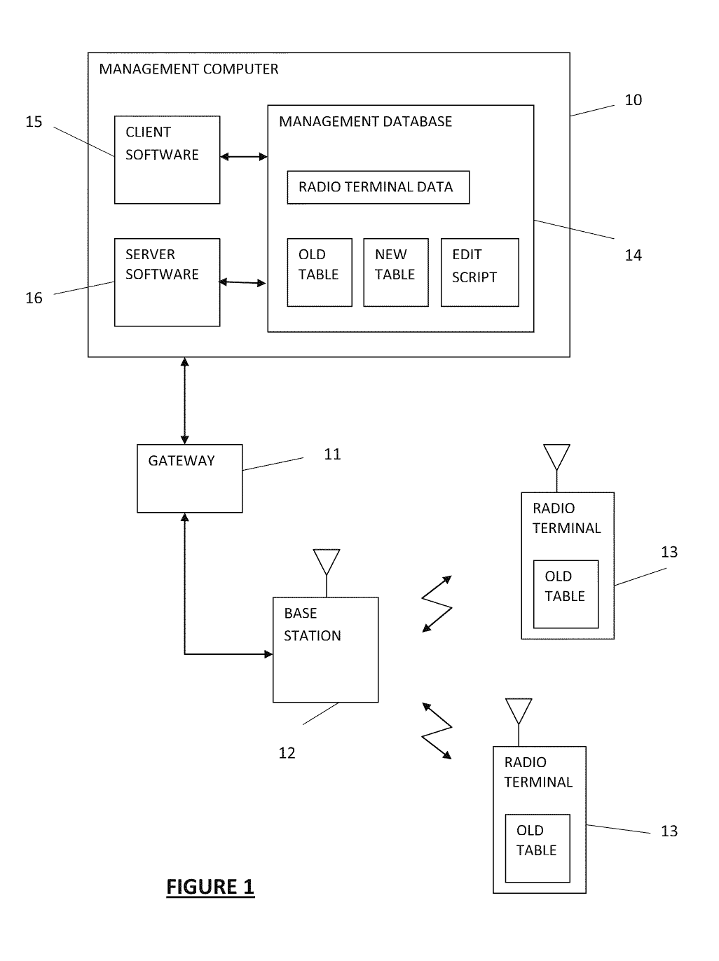

FIG. 1 shows a simple radio network having a central management computer 10 connected through a gateway 11 to a base station 12. Radio signals are transmitted between mobile terminals 13 and the base station using one or more RF channels. In practice a network of this kind could involve several central computers of different kinds, dozens of base stations in many different arrangements, and a fleet of up to a thousand or more mobile terminals in use over a wide geographical area. Each mobile terminal contains software and data which may be updated using OTAP. The data is typically stored in tabular form, represented here as an “old table”, to be updated or converted to a “new table”. The management computer contains a database 14 which stores data relating to the terminals, including copies of the old tables which are stored by each terminal. The management computer also contains client software 15 and server software 16.

A typical process of deployment and updating of mobile radio terminals takes place as follows:
1) Radio terminals 13 are programmed by the client software 15 before use in the field. This allows the client software to deploy the required software and configuration data onto the terminal. The client software records the state of the terminal in the central management database.
2) Client software 15 is later used to modify the desired application software version and/or configuration data required in the terminals, as stored in the central management database.
3) Server software 16 creates patch files for any updated software to be delivered to the terminals.
4) Server software 16 creates an update file for any configuration data changes. The update file contains an edit script which is used by the respective terminal to convert an old table into a new table.
5) Server software 16 creates data messages and uses the data gateway to broadcast these messages over-the-air to the terminals.
6) Terminals 13 send response messages to the fixed network asynchronously.
7) Once all updates have been acknowledged as being received by the terminals 13, the server software sends an activation command to the terminals. Optionally this step can require input from a fleet manager who manually initiates an activation of the updates.
8) Upon receipt of an activation command the terminals 13 apply the updates to the software and configuration data. Dependent on the configuration of the terminal the application of the updates could be a) upon receipt of the command; b) at next power up; c) on initiation by the radio user.

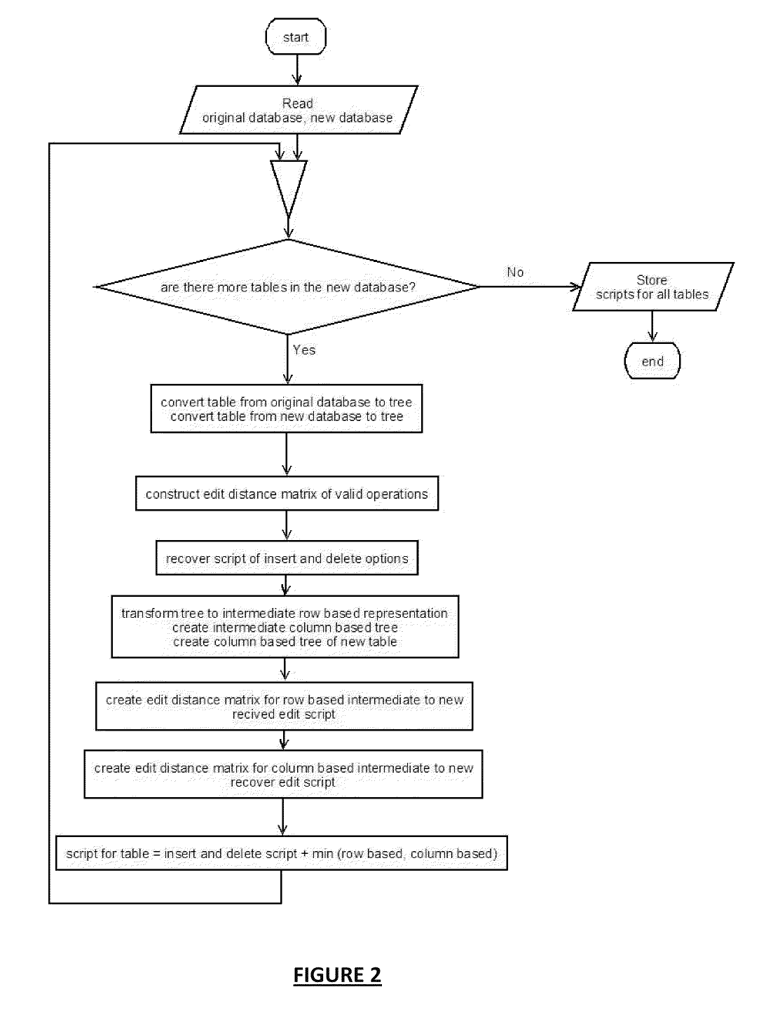

FIG. 2 outlines how one or more edit scripts may be created in the central management database 14 according to the differences between old data tables which exist in a fleet of terminals and corresponding new tables which are subsequently required. For each table in the database the client software 15 converts the old and new table data into old and new tree representations which are then used in an edit distance matrix. An edit path is then calculated using only a limited range of operations which affect the length of the old table, and a first partial edit script is recovered. An intermediate tree representation of the data is generated by applying the script to the old table data. A pair of edit paths and corresponding partial edit scripts are then calculated between the intermediate tree and the new tree using both row major and column major forms. The cost of each of these second partial scripts is calculated and whichever has minimum cost is selected. A full edit script for conversion of the old table to the new table is then formed by combining the first partial script with the selected second partial script.

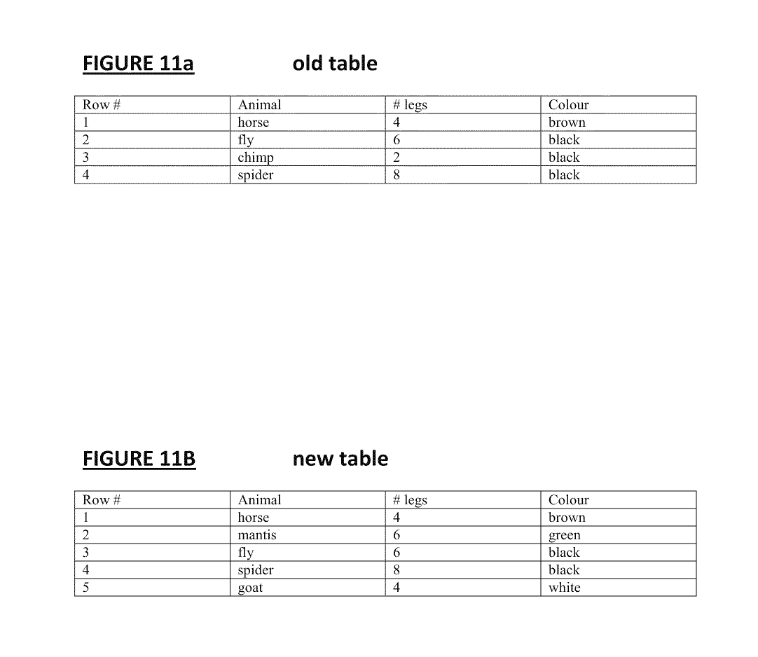

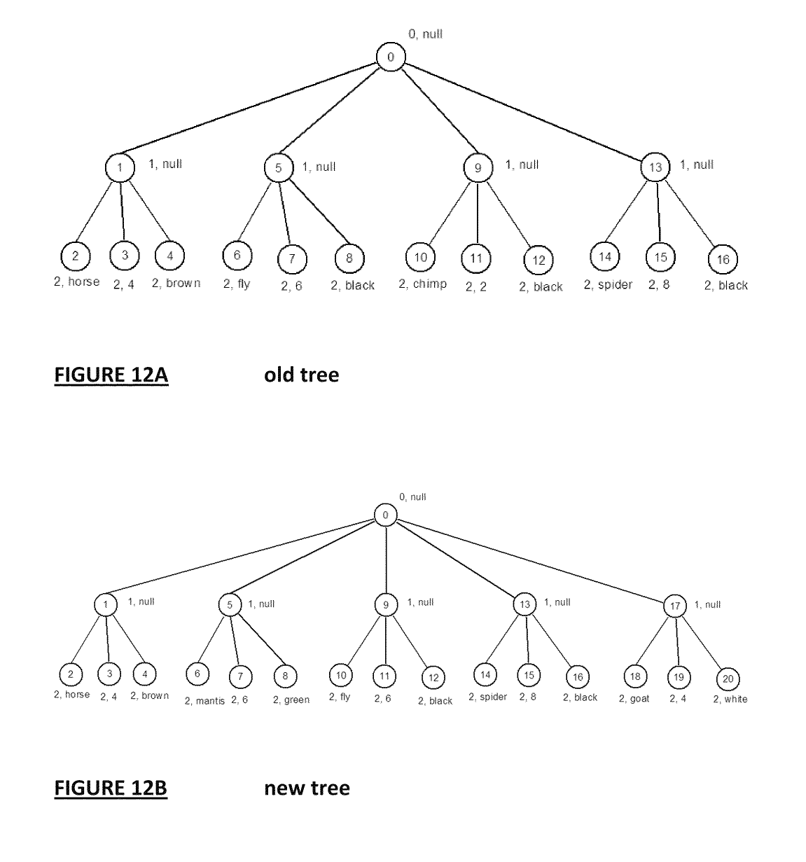

In relation to FIG. 2, the old and new tables are preferably converted into trees by considering each item of data in the table as a leaf node of depth or degree 2. In row major form each row in the table becomes a sub-tree with leaves containing the data values joined to a node of degree 1 which has a null value. In column major form each column in the table similarly becomes a sub-tree with leaves containing the data joined to a node of degree 1 having null value. The leaves are said to be labelled by the data values. All nodes of degree 1 are joined to a root node of degree 0, also of null value. The sub-trees formed by consecutive rows or columns are ordered from left to right, in “pre-order”. Each node is numbered consecutively by moving downwards in the tree, and left to right. Examples of the conversion of tables to trees in this way are given by FIGS. 11A, 12A and 11B, 12B.

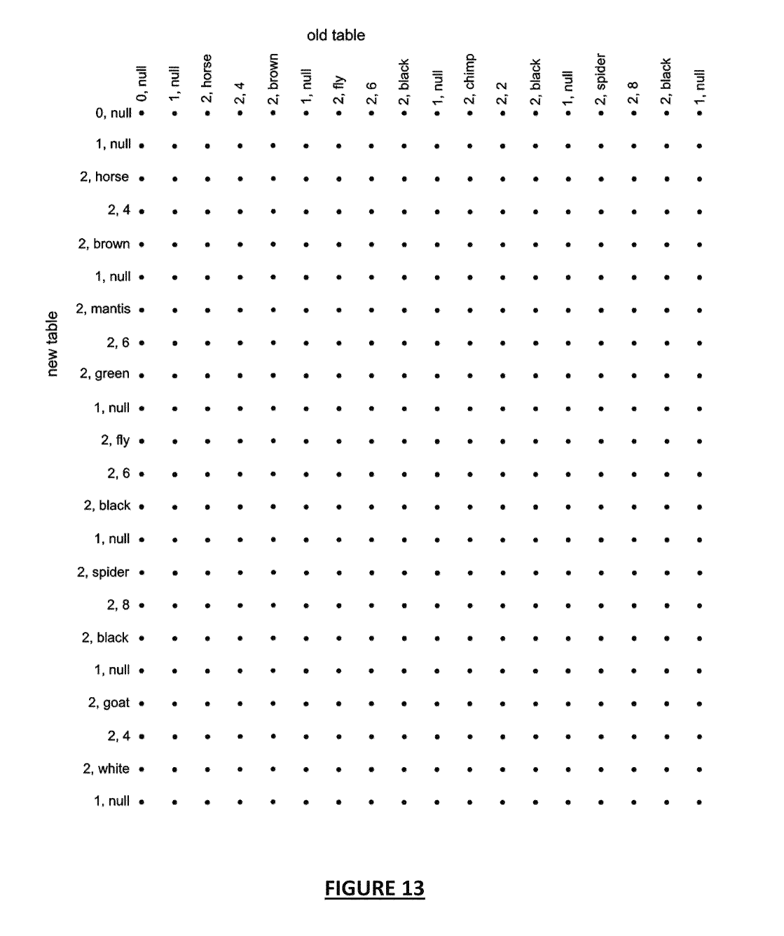

Also in relation to FIG. 2, the edit distance matrices are preferably formed from two rooted, ordered, labelled trees having degree 2. The two axes of the matrix are formed by respective sequences of degree-label pairs. Examples of matrices formed in this way are given by FIGS. 12A, 12B, 13.

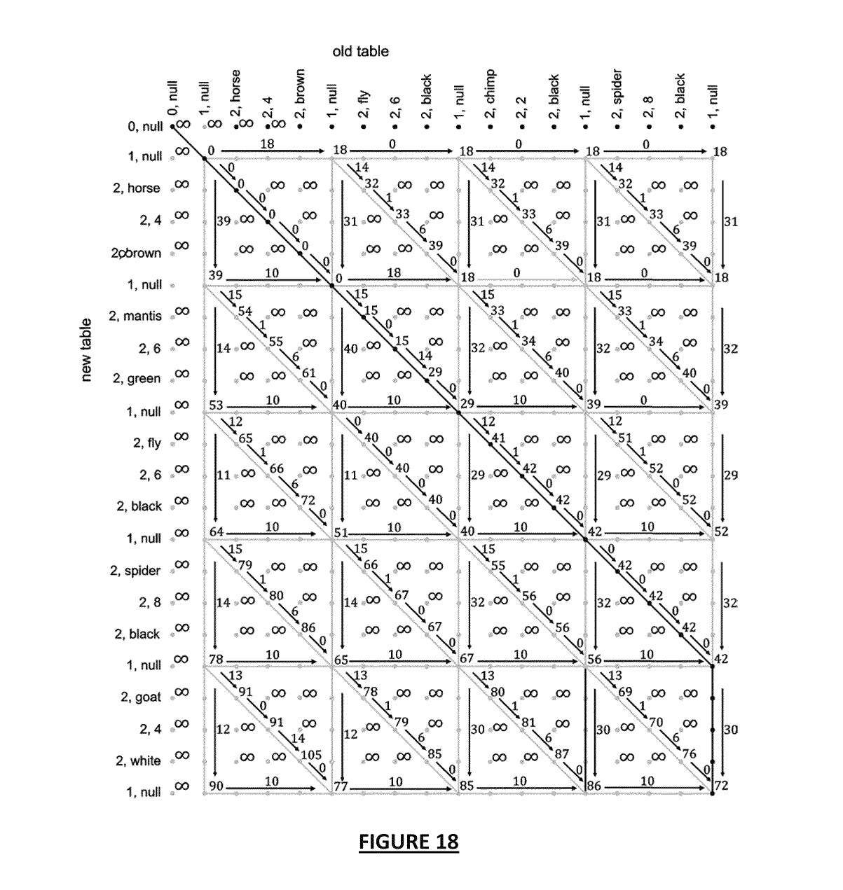

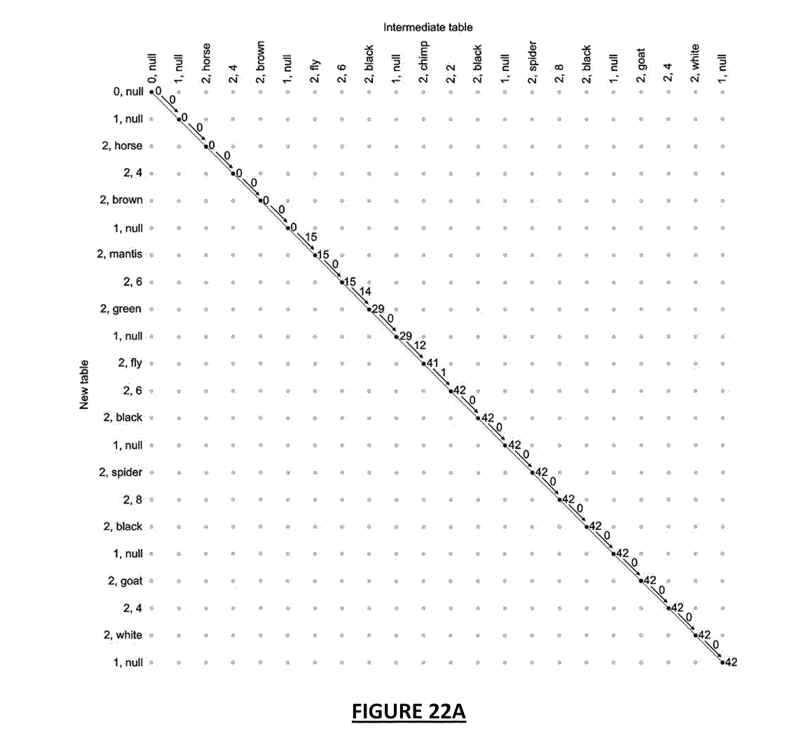

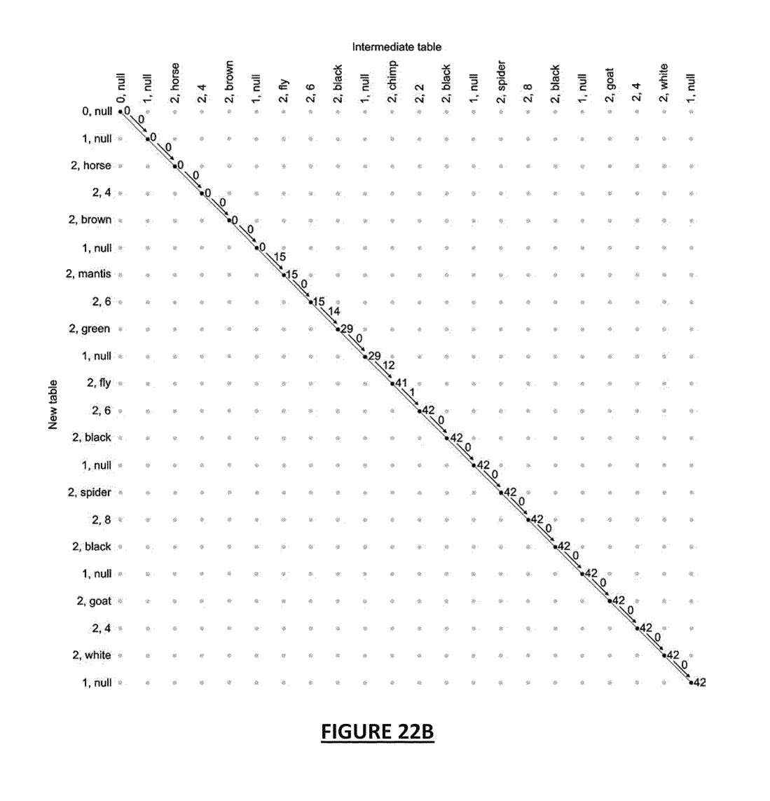

Further in relation to FIG. 2, the first partial script is preferably formed only from operations which affect the length of the old tree, so that the length of the intermediate tree is the same as the length of the new tree. Only those operations which involve insertion or deletion of complete sub-trees in the old tree are considered valid. Operations which involve insertion or deletion of individual nodes are not available. An example of an edit path formed in this way is given in FIG. 18. In contrast, the second partial scripts are calculated using only operations which relabel nodes in the intermediate tree. Examples of edit paths formed in this way are given in FIGS. 22A, 22B.

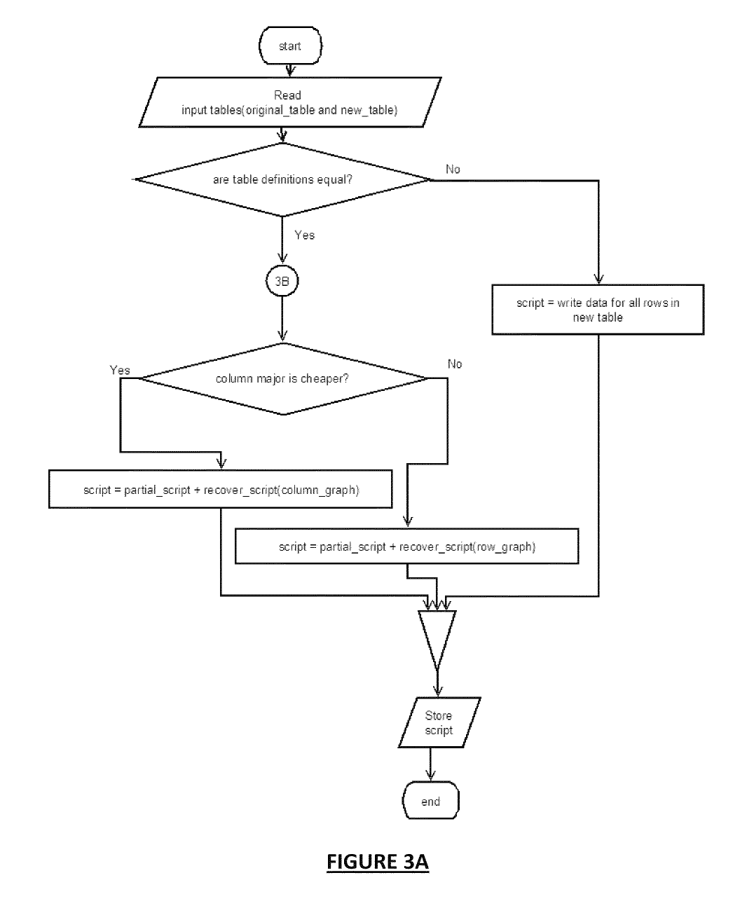

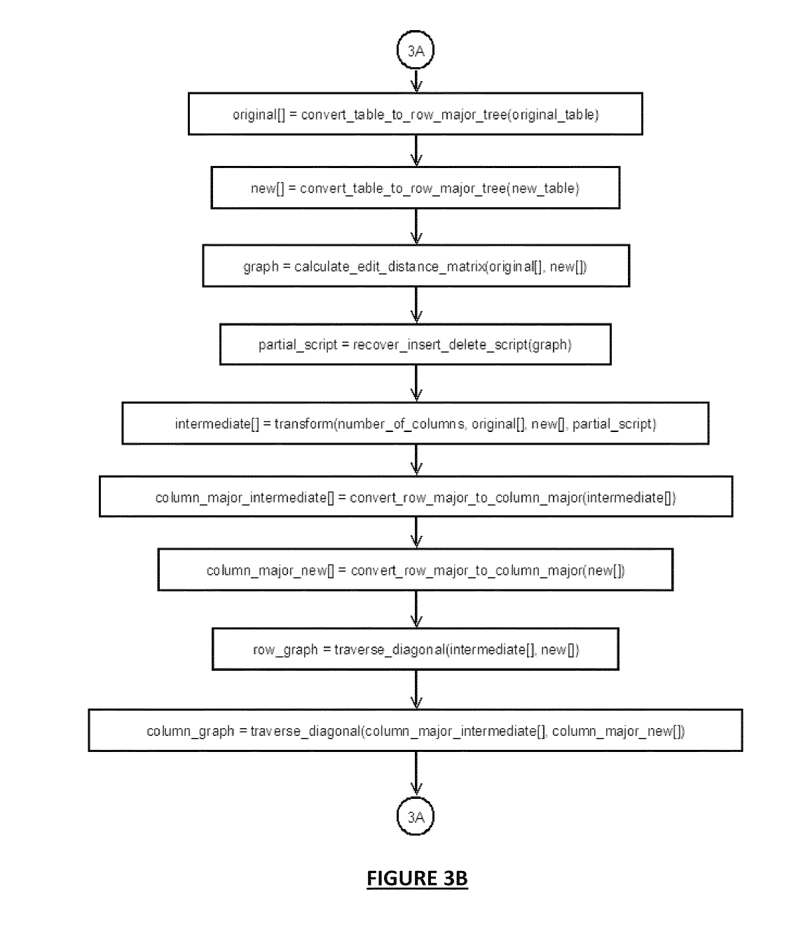

FIGS. 3A, 3B outline a routine for generating an edit script for an individual table. The inputs of the routine are two tables of data, namely the old and new tables. The routine first checks that the tables are suitable for patching. Based on a set of primitives identified for updating the database on remote terminals there is no way for scripts to be created that change the length of columns (the number of bits of data in the field) or that add or remove columns. Any such changes will mean that the entire content of the table must be sent. If the structure of the tables (their definition) is equal then the process proceeds as previously described.

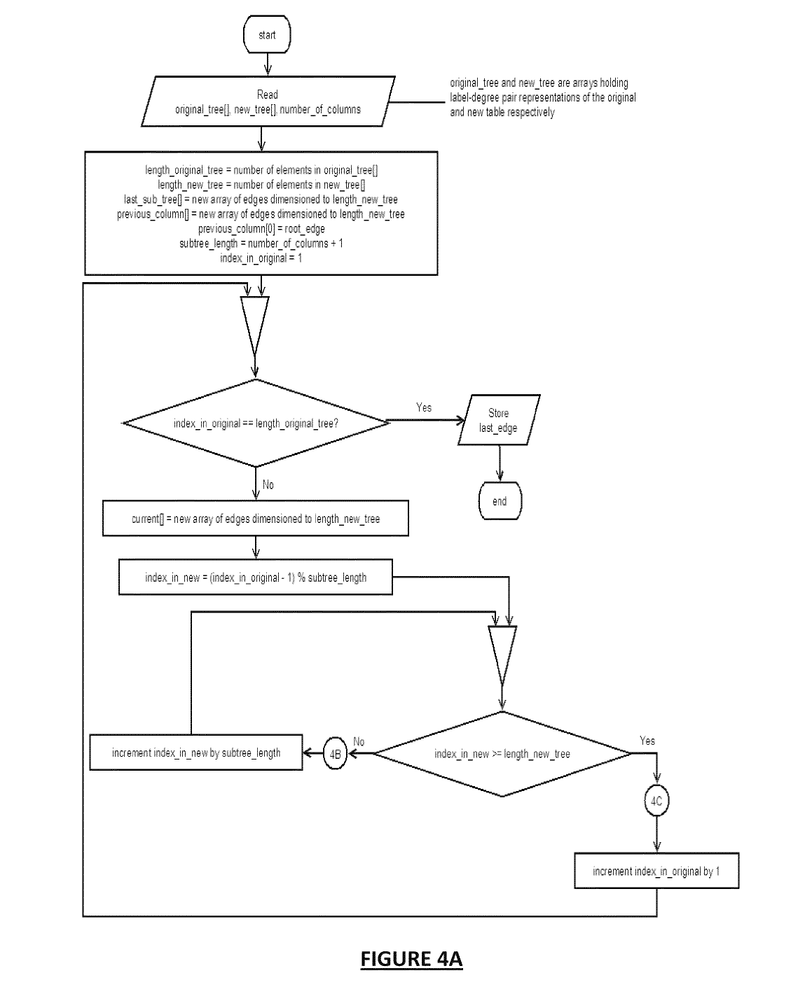

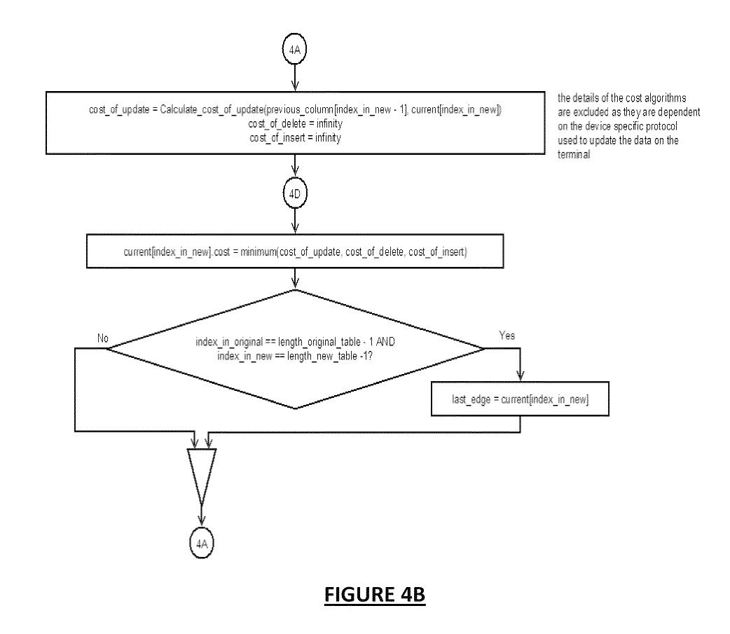

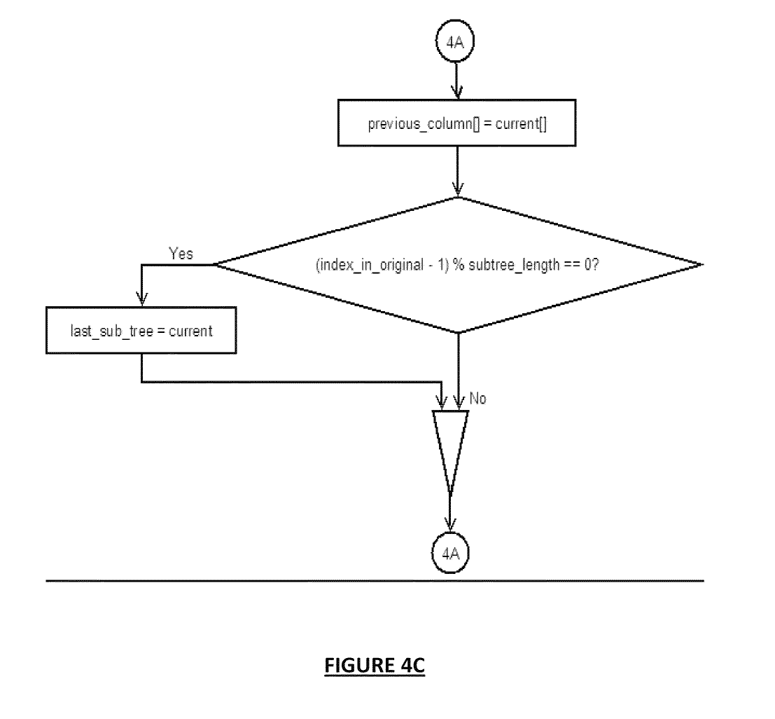

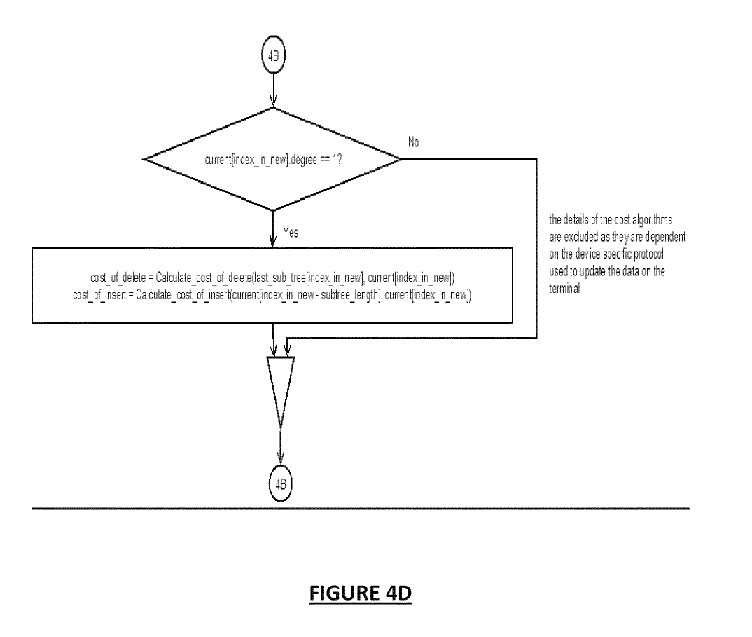

FIGS. 4A, 4B outline a routine having two nested loops that are used to process the two trees and calculate the edit distance between them. Firstly some variables are initialised.

last_sub_tree[ ] is an array holding the last column of the matrix that held the root nodes of a subtree in the horizontal axis. This is relevant to calculations in the main body of the routine that are only performed when a complete subtree (or row) is being dealt with i.e. delete operations.

previous_column[ ] holds the column at the previous index in the outer loop which is required for calculating the cost of update operations.

subtree_length (which is used in a number of calculations) is initialised to the number of columns (in the original table) plus one. The additional increment is to account for the root node of the subtree (the order 1 nodes in the tree) that is added in the conversion from a table to a tree.

The outer loop in the routine runs from one to the length of the original table. This processes each column of the matrix. The zero'th column can be ignored as only the root node (zero'th index in the zero'th column) is of interest to the edit script.

The method limits the comparison of nodes in the two trees to vertices where the column index in the original table matches the column index in the destination table. This is a consequence of the limitation that there are no insertions or deletions of leaf nodes. To this end the inner loop is initialised to the index in the original table (loop counter value from the outer loop)-1 modulo subtree length (effectively identifying the offset within the destination tree to the column that matches the position in the original tree). The inner loop is then incremented by the length of the subtree at the end of each iteration. This means that only those vertices where the column index in the source matches the column index in the destination are considered for each iteration of the outer loop.

Each iteration of the inner loop calculates the cost of performing an update operation. If the outer loop counter is exactly divisible by the length of the subtree then we are at the root of a subtree and the costs of insert and delete are also calculated during each iteration of the inner loop. When the final node in the matrix is encountered, that operation (the final node in the directed graph representing the edit script) is returned from the routine.

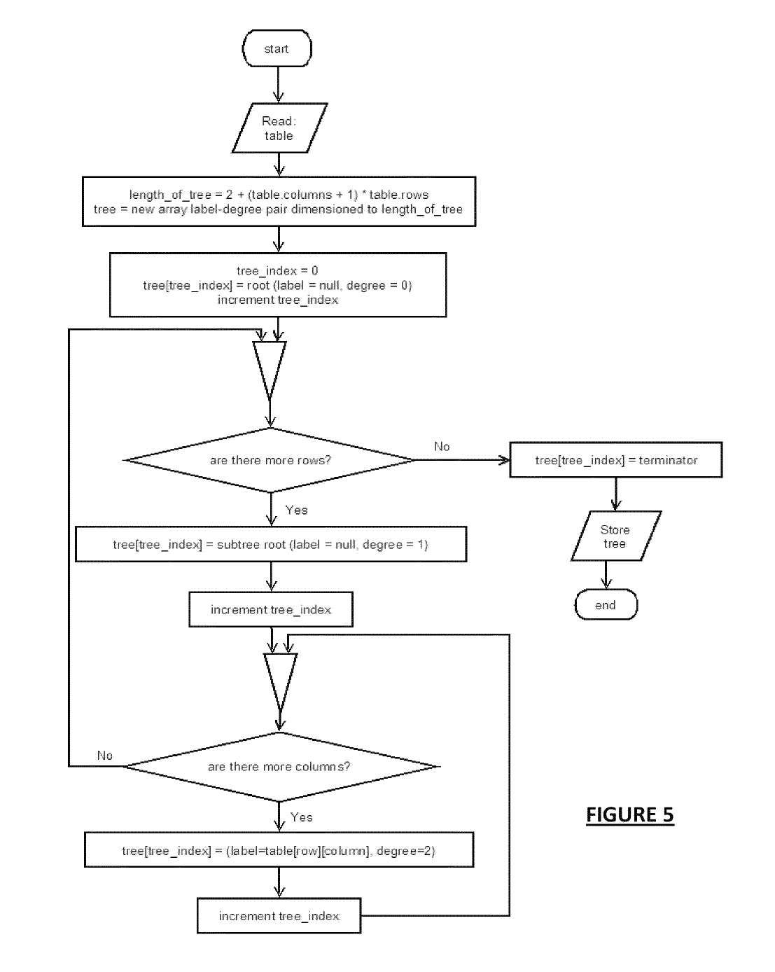

FIG. 5 outlines a routine for converting a table into a rooted, ordered, labelled tree (in pre-order or row major). A degree zero node is used as the root of the whole tree. Then for each row a degree one node is used as a subtree root. For each column the value for the current row is added as a degree two node in the tree. A degree one node is used as a terminator to simplify the calculation of insert and delete operations.

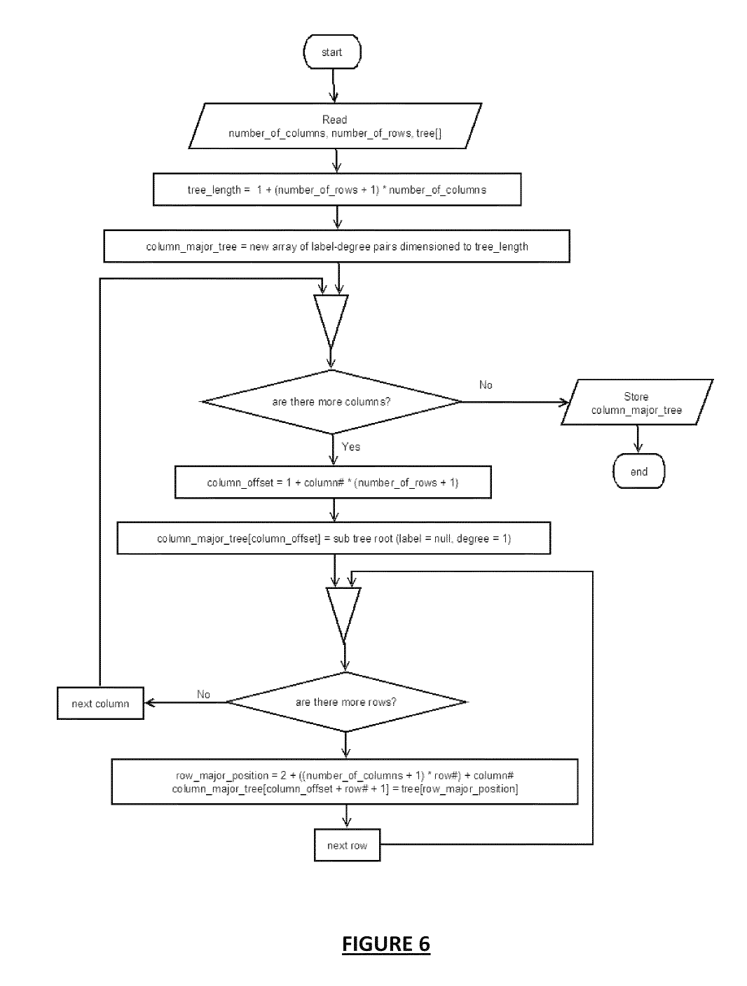

FIG. 6 outlines a routine which converts a row major (pre-order) tree into and column major (post-order) tree. This amounts to reading a tree in row major order and writing it in column major order. The flowchart presents a method for doing this that chooses to iterate through the output tree and calculate the read position from the source tree based on subtree length multiplied by the current row index plus the column of interest.

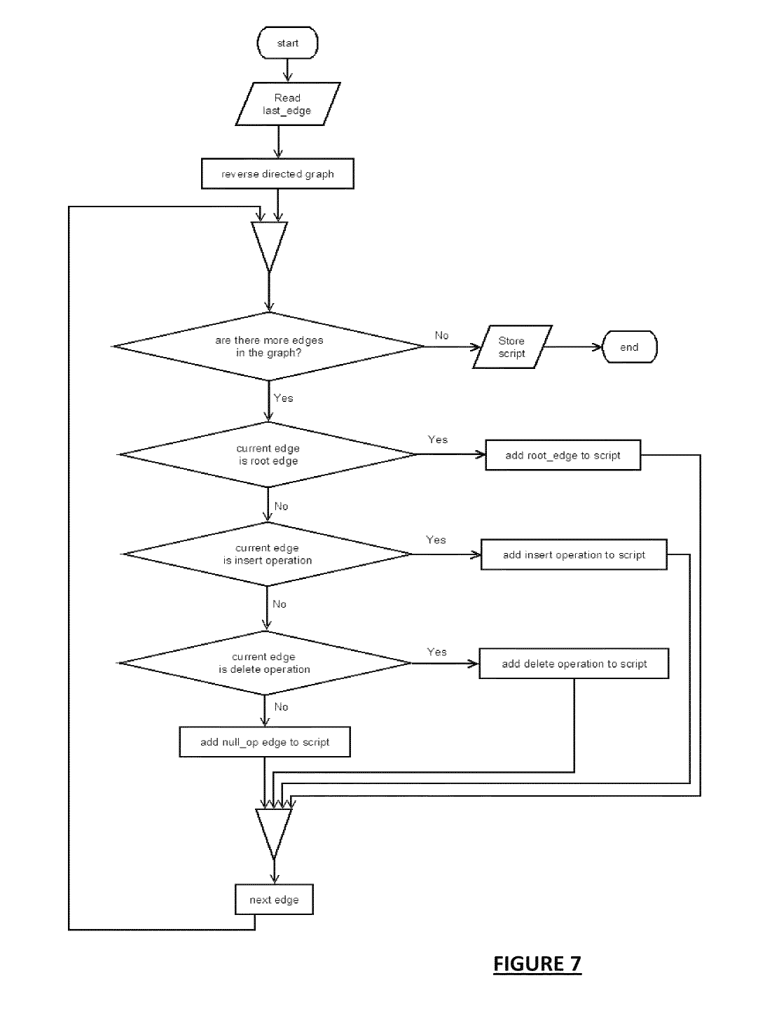

FIG. 7 outlines a routine for the recovery of a partial edit script containing only that subset of the operations that affect the length of the table (insert and delete operations). The routine reverses the order of the edges (or operations) in the directed graph and then converts any operation that is not an insert or delete into a null operation.

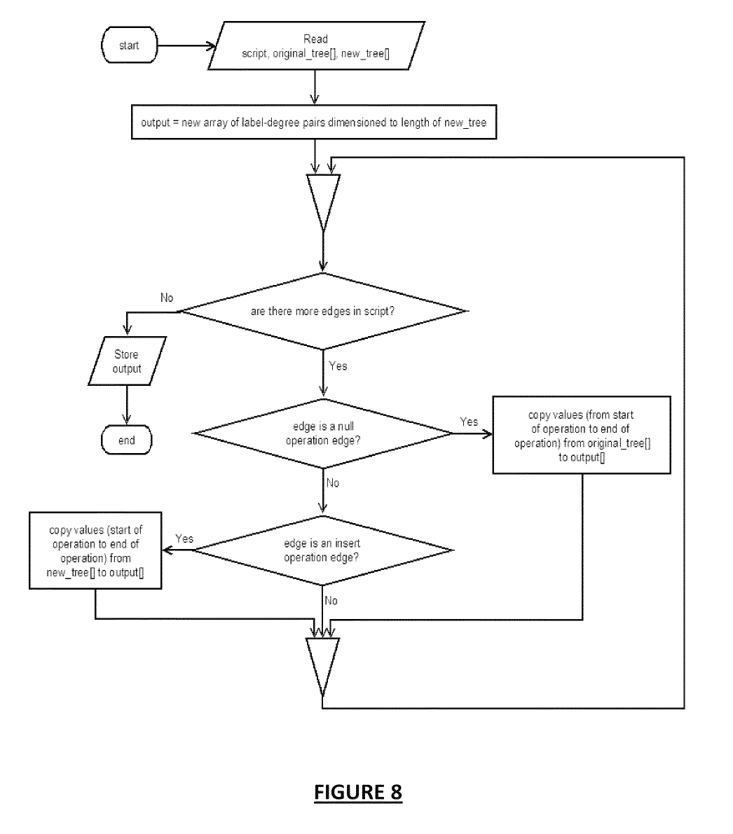

FIG. 8 outlines a routine for applying the partial edit script from FIG. 7 to the source tree to create an intermediate tree of the same length as the destination tree. This intermediate tree will hold the data from the source tree excluding those rows that have been deleted, except for the rows that have been inserted (where the data will match that of the destination tree). For null operations the routine copies the data from the source tree to the intermediate tree. For delete operations the routine increments the cursor in the source tree and performs no updates to the intermediate tree. For insert operations the routine copies the data from the destination tree and does not increment the cursor in the source tree.

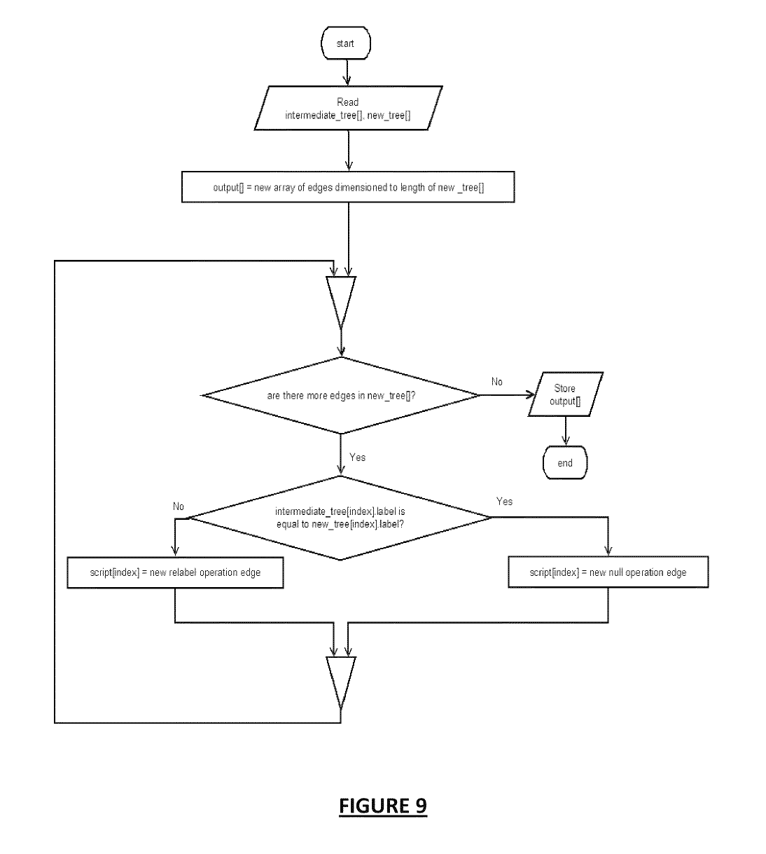

FIG. 9 outlines a routine which calculates the edit script once the trees are known to be the same length. This is a simplified version of the main edit distance processing. The algorithm is simply concerned with comparing index for index each position in both trees and determining whether or not the label should be updated.

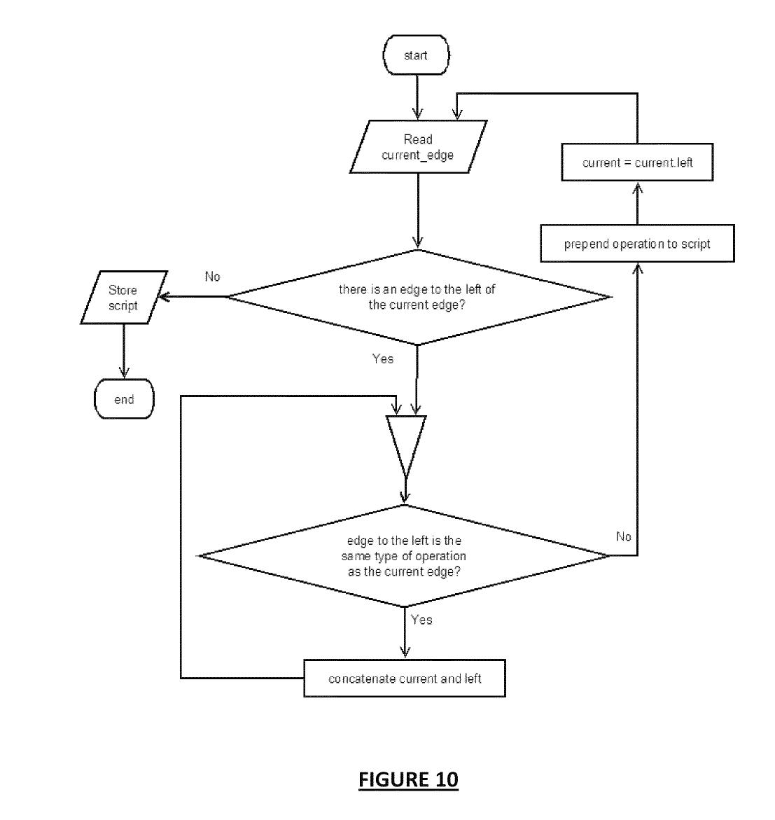

FIG. 10 outlines a routine responsible for recovering the edit script from a directed graph. The edges are read in the order they appear in the directed graph (so from the end of the two trees back towards the origin). Contiguous edges of the same operation type are concatenated to form larger operations (operations spanning more nodes in the tree). Once an edge cannot be concatenated with the next edge in the graph it is output to the script. This is repeated until there are no more edges to be processed.

FIGS. 11 to 30 relate to a simplified example of conversion of an old data table to a new data table. FIGS. 11A, 11B show tables having three columns: “Animal” which holds the name of a type of animal stored as a P-string; the first byte is used to store a count of the characters in the string, each character of the string is stored sequentially in the subsequent bytes, “# legs” which holds the number of legs that the type of animal normally has, this is stored as a single byte), “Colour” which holds the colour that is most usually associated with the type of animal as a P-string.

FIG. 12A shows a representation of the old table data in FIG. 11A represented as a rooted, ordered, labelled tree. Each node in the tree is annotated with its order number. Nodes are numbered in pre-order. The textual label next to each node holds the degree of the node (depth in the tree) and its label (the data for that cell in the tree).

FIG. 12B shows a representation of the new table in FIG. 11B as a rooted, ordered, labelled tree. The annotation is the same as for FIG. 12A. In this case the changes can be seen. The second sub-tree (rooted at node 5) now holds different details. The sub-tree rooted at 9 holds the data that was previously rooted at 5. An additional sub-tree (rooted at 17) has been added to the tree. This represents the insertion of a row, the deletion of another row, and the appending of a new row to the end of the table.

FIG. 13 shows an edit distance matrix formed by the trees in FIGS. 12A, 12B, stored as arrays of label-degree pairs. The old and new data are along the horizontal and vertical axes respectively.

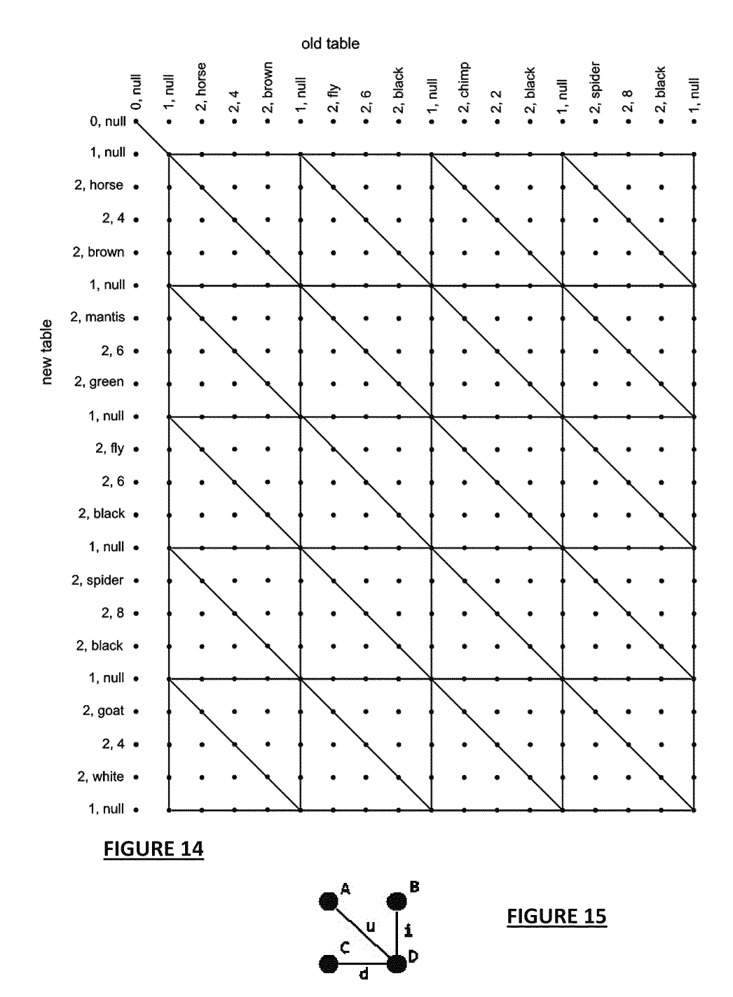

FIG. 14 shows the limited range of edit paths which are available in the matrix of FIG. 13. Operations which are impossible or inefficient are discounted, specifically operations which involve insertion or deletion of individual degree 2 nodes, or relabelling of nodes for which the destination vertex in the matrix represents nodes having an unequal degree. The cost of each available edit path must be determined in terms of individual steps of the cursor between vertices.

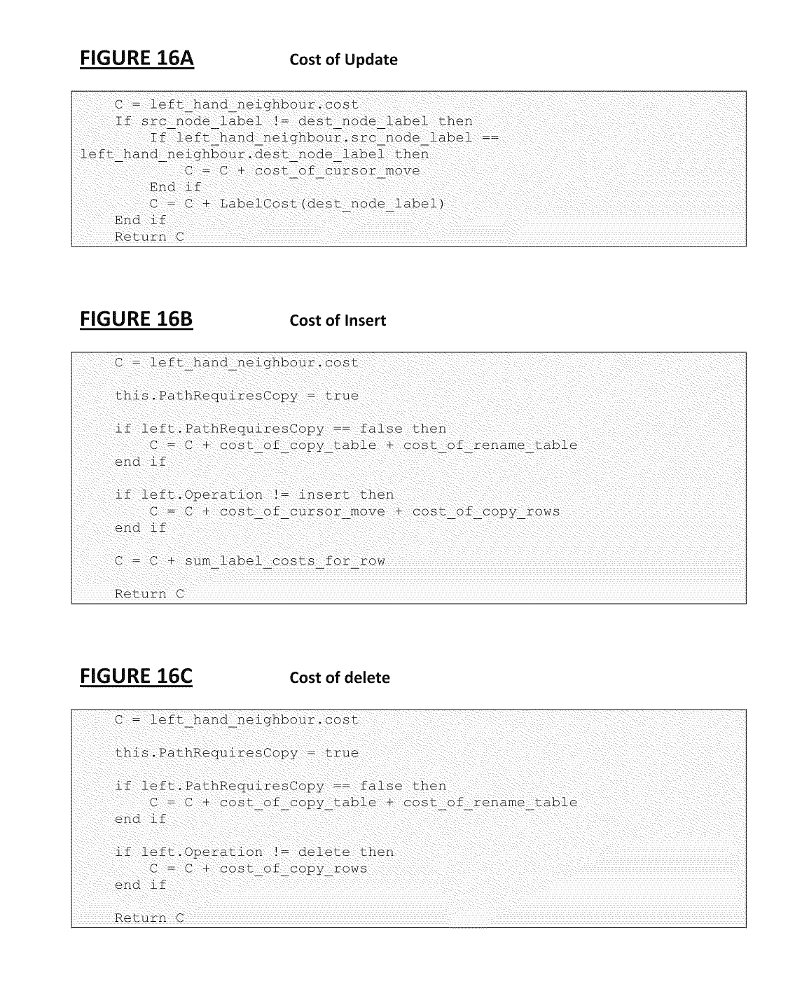

FIGS. 15 and 16A, 16B, 16C indicate how the steps in an edit path may be costed. One column of the matrix is loaded at a time into the memory of the management computer. At any point in time the current column, the previous column (if such exists) and the last column for a degree 1 node in the old data (if such exists) are held in memory. The cost of traversing to each node in the current column is calculated in turn by taking the minimum of the cost of the nodes to the left of the current node in graph. The cost of a node to the left is calculated by the cost of that node itself plus the cost of the operation to traverse from the previous node to the current node. The minimum cost of the cost of inserting (CI), cost of deleting (CD), and cost of updating (CU) is used to determine the root to and the cost of the current node.

The cost of node D in FIG. 15Error! Reference source not found. would be calculated as: Cost D=min {CU, CI, CD}

where:

CU=Cost A+u

CI=Cost B+i

CD=Cost C+d

This is complicated in the specific case considered here as the table structure of the data precludes allowing insert or delete to operate on individual nodes. This means that only nodes at the start of a row are valid for the delete or insert operations and those operations traverse to the start of the previous row.

The example code for Cost of Update in FIG. 16A adds the cost of the left hand neighbour (vertex diagonally to the left of the current vertex) to the cost of updating the current node in the source tree to match the destination tree. If the labels of the source and destination nodes are equal then the cost of that operation is zero. Otherwise if the previous operation is not also a write then this operation also incurs the cost of moving the cursor to the current location in the source table. The remainder of the cost of the update operation is based on the cost of transmitting the data for the label of the destination node. LabelCost calculates the number of bytes to transfer the label for a particular node of the tree i.e. for the “Animal” or “Colour” columns the cost of the label is one byte for the count of the characters and then one byte per character, for the “# legs” column the cost is 1 byte.

The example code for Cost of Insert adds the cost of the left hand neighbour (the vertex above the current vertex) to the cost of inserting a row at the current location. The cost of inserting a row depends on whether any previous insert or delete operations have been encountered on this graph. If they have not then the additional cost of copying the table and renaming the table are incurred for this operation. If the left hand neighbour is not an insert operation then the current operation also incurs the cost of moving the cursor and of copying one or more rows of data from the original table to the new table.

The example code for Cost of Delete adds the cost of the left hand neighbour (the vertex horizontally to the left of the current vertex) to the cost of deleting a row at the current location. The cost of deleting a row depends on whether any previous insert or delete operations have been encountered on this graph. If they have not then the additional cost of copying the table and renaming the table are incurred for this operation. If the left hand neighbour is not a delete operation then the current operation incurs the cost of copying one or more rows from the source table to the destination table. If the left hand operation is a delete operation, no additional cost is incurred for deleting additional contiguous rows.

The following constants have been used for these examples, while concerns such as bit packing and packetization overhead have been ignored in the cost calculations.

Constants:

cost_of_cursor_move: 8 bytes

cost_of_copy_table: 4 bytes

cost_of_rename_table: 4 bytes

cost_of_copy_rows: 10 bytes

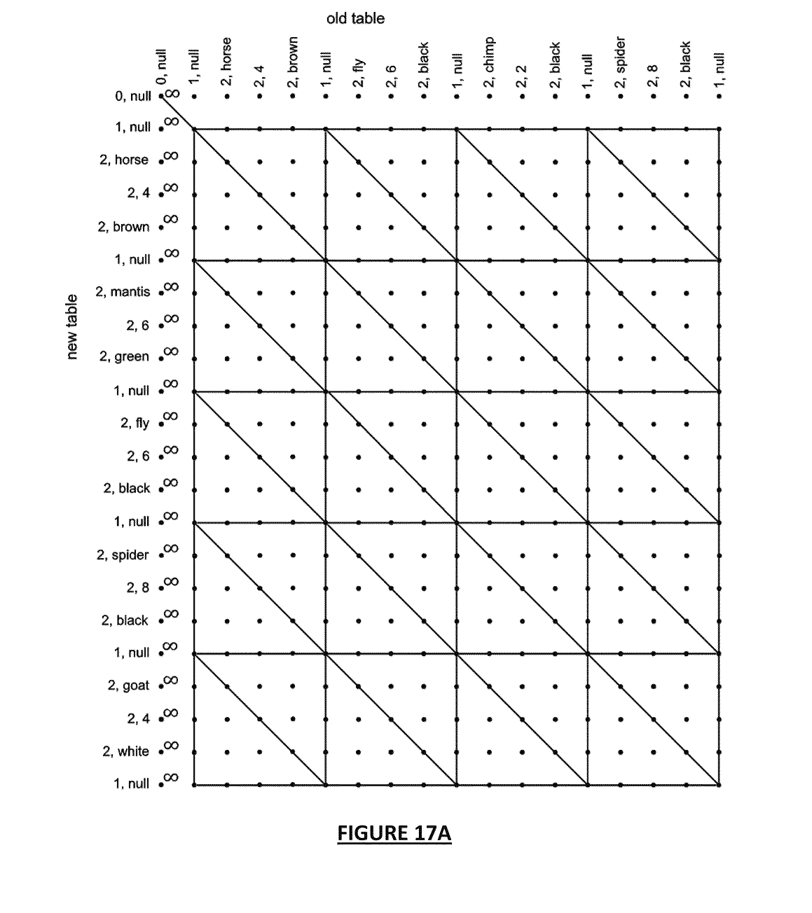

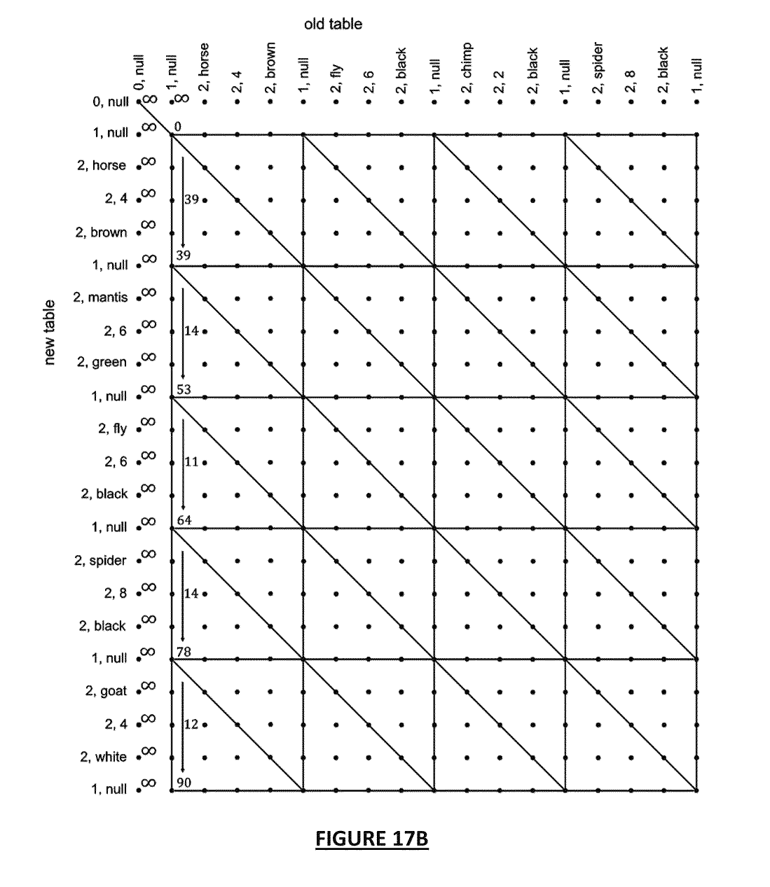

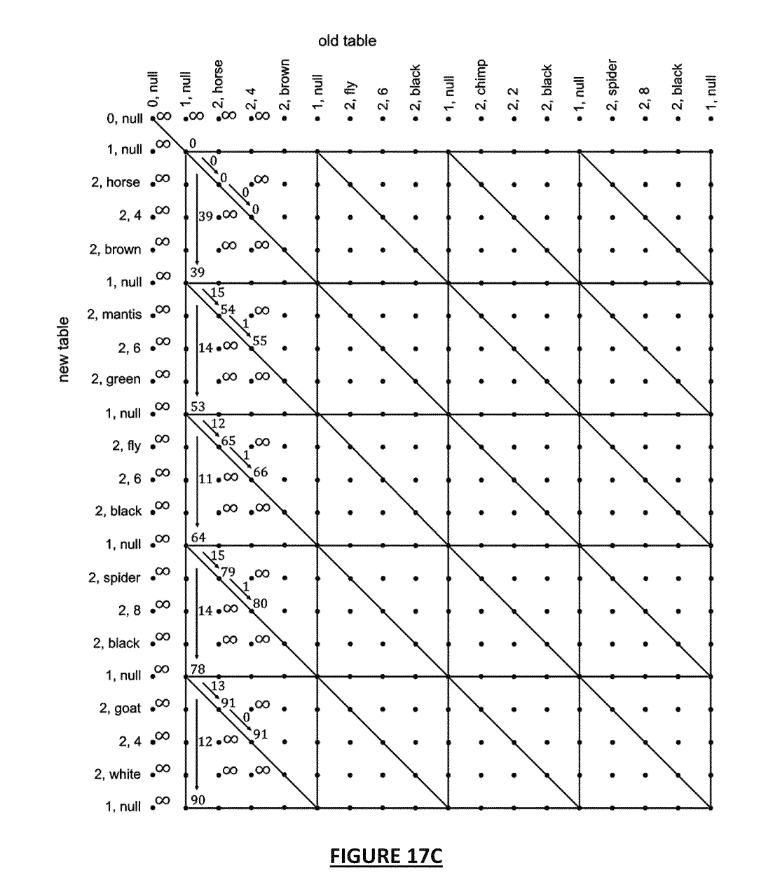

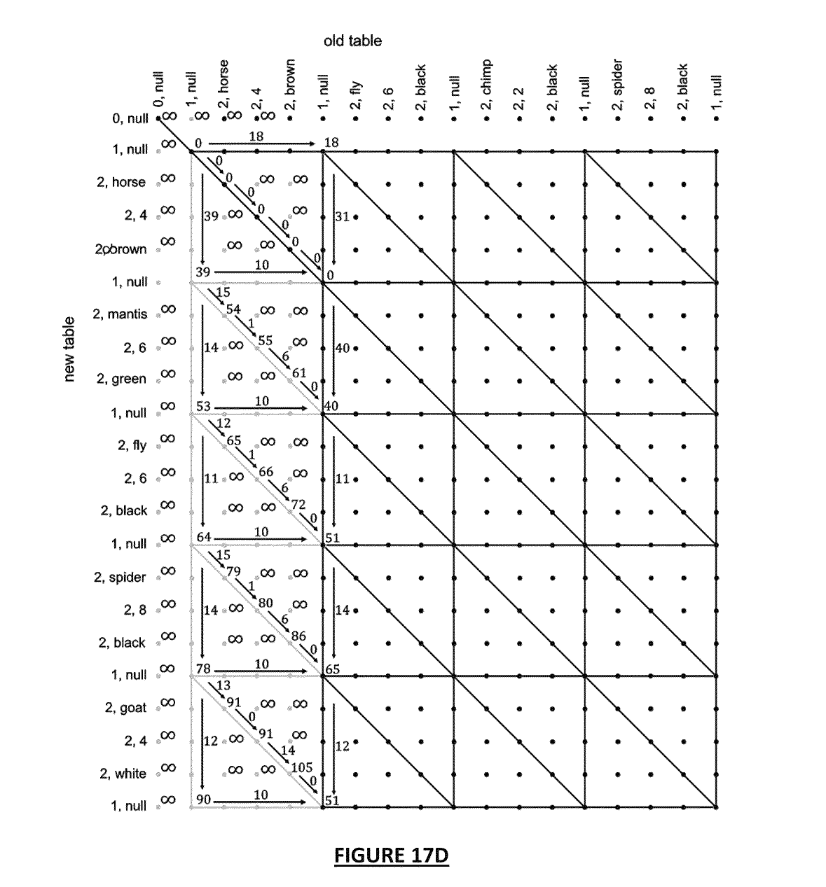

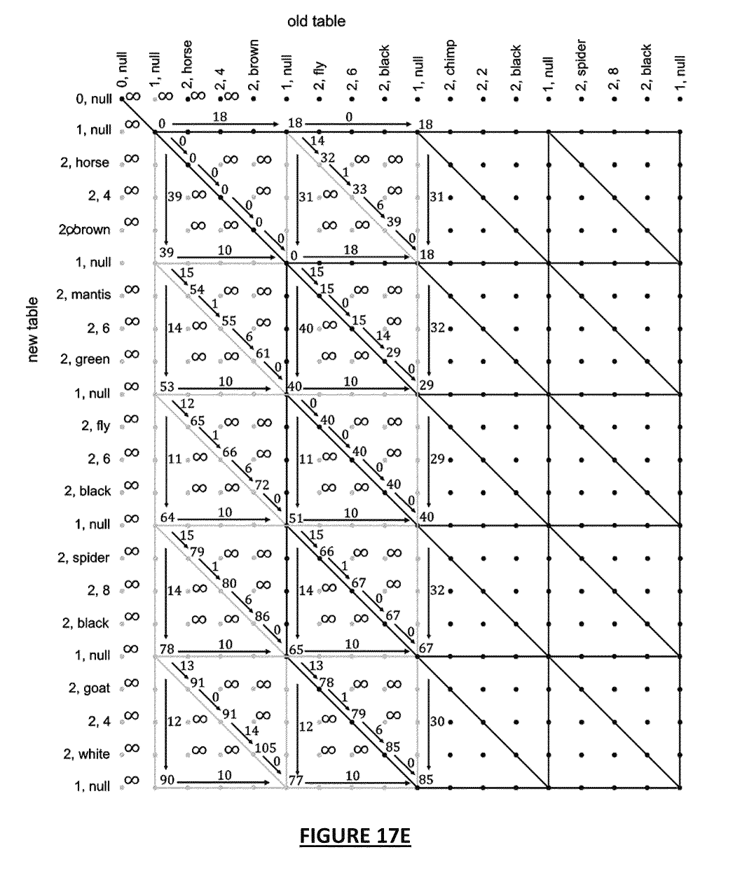

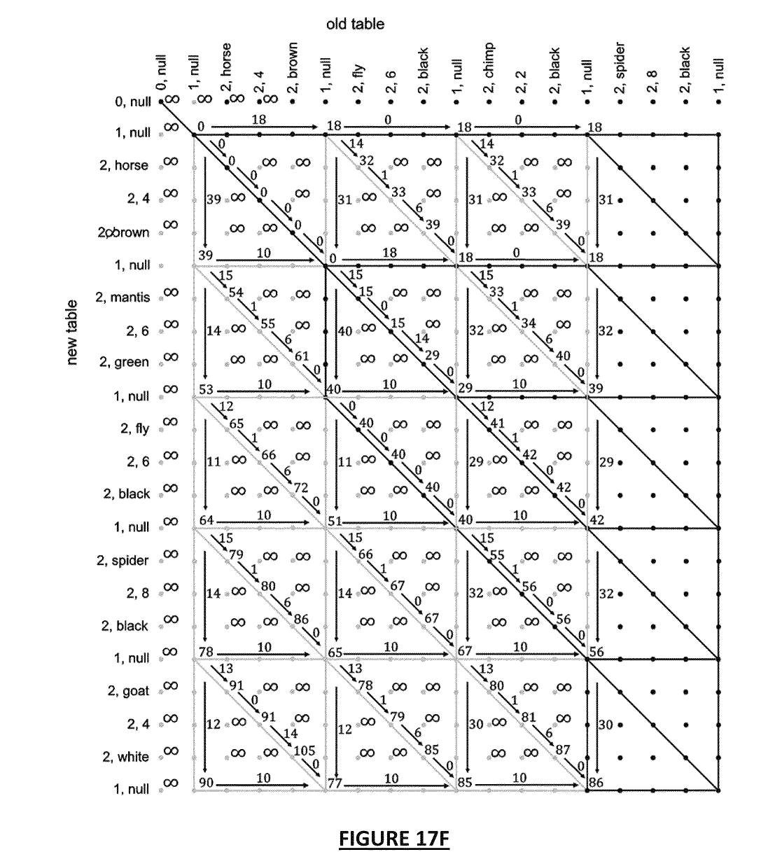

FIGS. 17A to 17F show iterations in a routine for costing edit pathways in the matrix of FIG. 14, while FIG. 18 shows the optimal edit path. In FIG. 17A, the cost of the origin node is zero and all other nodes in the column are unreachable and therefore incur infinite cost (this is used to exclude all paths that touch these nodes of the graph from consideration).

In FIG. 17B the cost calculations are carried out as follows:

0'th node: cannot be reached. Cost is infinite.

1st node: labels are equal. Cost is zero.

2^{nd} node to 4^{th} node: cannot be reached. Cost is infinite.

5^{th} node: insertion of a row. This is the first insert or delete on the path (cheapest route back to origin includes one zero cost ‘update’ operation.

left.cost+cost_of copy_table+cost_of rename_table+cost_of_cursor_move+cost_of_copy_rows+LabelCost(horse)+LabelCost(4)+LabelCost(brown)==0+4+4+8+10+6+1+6=39

6^{th} node to 8^{th} node: cannot be reached. Cost is infinite.

9^{th} node: insertion of a row. This is not the first insert or delete. The previous operation is an insert operation. Cost of left is 39.

left.cost+LabelCost(mantis)+LabelCost(6)+LabelCost(green)==39+7+1+6==53

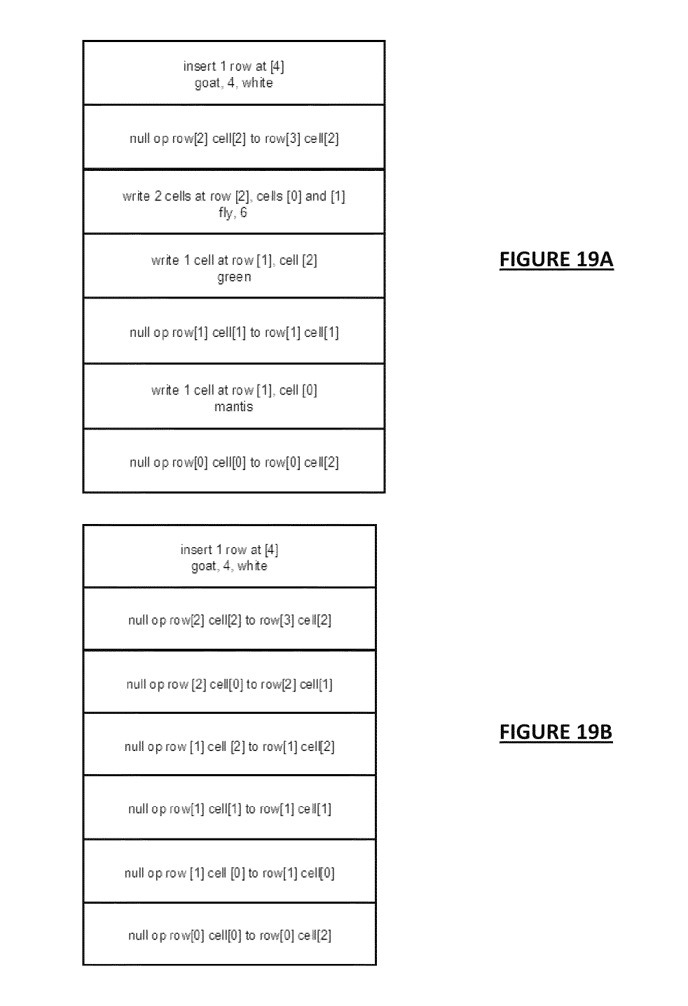

As the end of each of the iterations in FIGS. 17A to 17F is reached, only those vertices in the matrix that are part of valid paths are retained in memory. So at the end of the fourth iteration in FIG. 19, the program is holding the second, third and fourth columns in memory but releases the third. The second is still required as no other degree 1 column has yet been encountered. The fourth column is still required as the previous column input to the next iteration. The vertices in the third column that are not part of any valid directed graph can be freed are at this point. In this case at the end of the sixth iteration in FIG. 17C, the program reaches the end of the first row of data. At this point the insertion and deletion operations can be calculated.

FIG. 19A shows the script that would recovered from the matrix shown in FIG. 14. In recovering the script, all adjacent edges that represent the same class of operation are concatenated to form single operations. This process is recognised in the costing algorithms that are used to construct the matrix. This script is then rewritten to produce a script that only contains operations that change the length of the table (insert row or delete row). The resulting rewritten script is shown in 19B. This would form the first partial script mentioned in relation to FIG. 2.

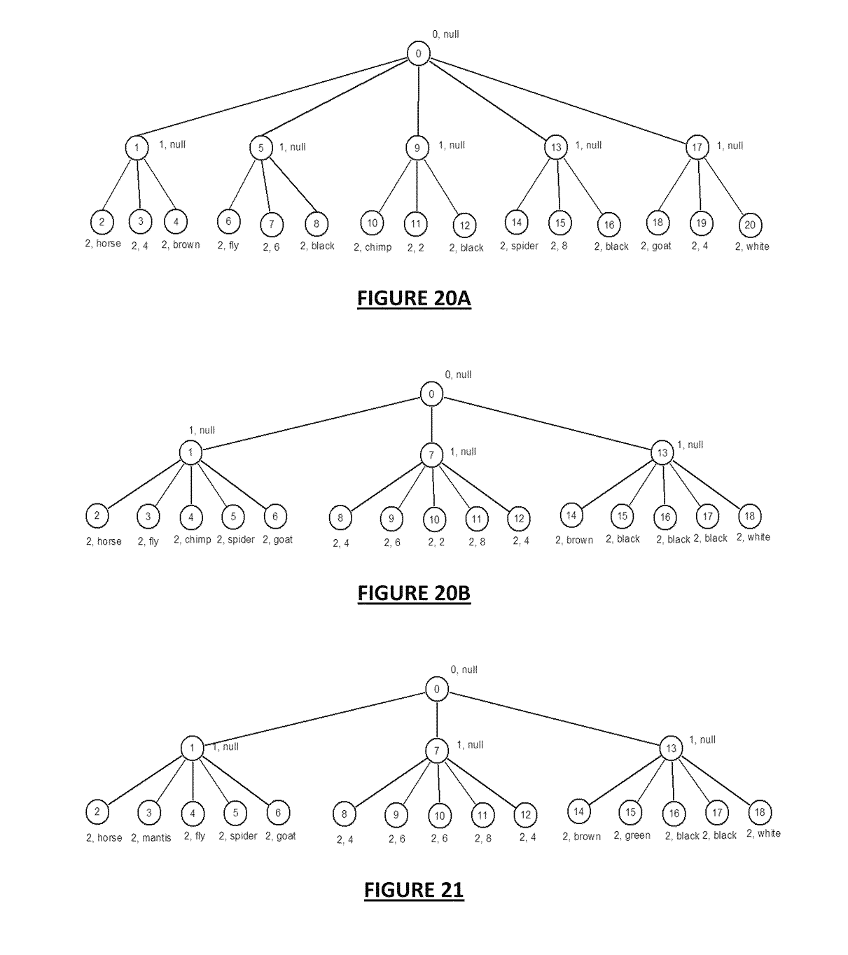

FIGS. 20A, 20B show the old tree with the length script from FIG. 19B applied in both row major and column major forms respectively. FIG. 21 shows the new tree converted to a column major form for the purpose of determining the second partial script mentioned in relation to FIG. 2.

FIGS. 22A, 22B show the edit distance matrices for the new tree in relation to the row major and column major forms of the intermediate tree in FIGS. 20A, 20B respectively. The optimal edit paths involve only relabelling steps and are therefore diagonal, because the length of the intermediate tree matches the length of the new tree. The path calculated for the column major forms is seen to have the lowest cost.

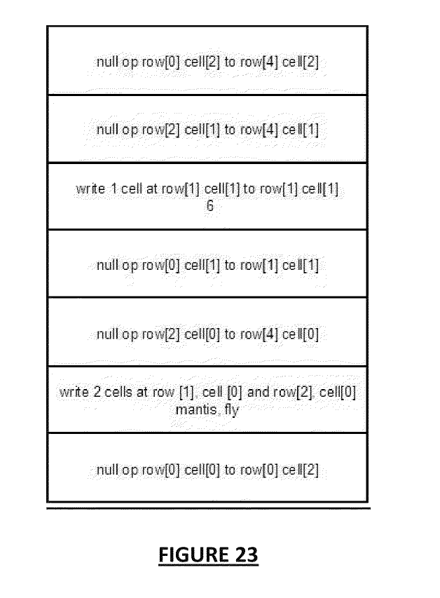

FIG. 23 shows an edit script generated from FIG. 22B which would form the second partial edit script to be combined with the script from FIG. 19B. In this case, the old and new data tables are relatively small, and the edit paths shown in FIGS. 22A, 22B are of approximately equal cost. Either could be chosen to have a script of minimum cost. In practice, the data tables may contain thousands of rows or columns and the differences created by the row major and column major forms of their respective trees could be more significant.

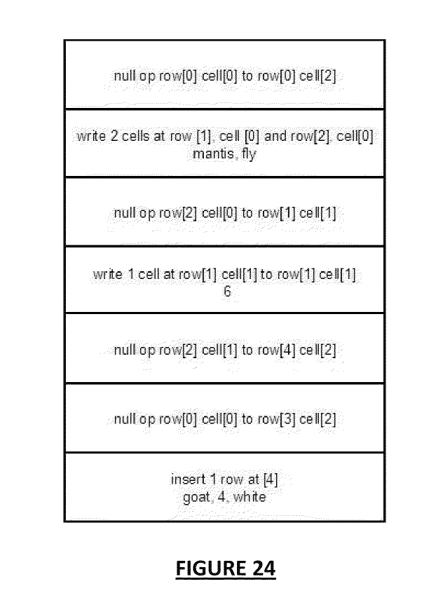

FIG. 24 shows a combined script derived from the scripts in FIG. 19B and FIG. 23. This script could be used to convert the old table to the new table.

1. A method of creating an edit script for conversion of an old data table to a new data table, the method comprising:
creating an old data tree and a new data tree from the old table and the new table respectively;
determining a first partial script which converts the old tree to an intermediate tree having the same length as the new tree; and
determining a second partial script which converts the intermediate tree to the new tree, and combining the first and second partial scripts.

2. A method according to claim 1 wherein the first partial script is determined as a minimum cost series of edits causing only insertions and deletions in the old data tree.

3. A method according to claim 2 wherein the first partial script inserts or deletes only complete sub-trees in the old data tree.

4. A method according to claim 1 wherein the second partial script is determined as a minimum cost series of edits causing only substitutions in the intermediate tree.

5. A method according to claim 1 wherein the first partial script is determined using an edit distance matrix with the old tree and the intermediate tree in row major form.

6. A method according to claim 1 wherein the second partial script is be determined using an edit distance matrix with the intermediate tree and the new tree in row major form.

7. A method according to claim 1 wherein the second partial script is determined using an edit distance matrix with the intermediate tree and the new tree in column major form.

8. A method according to claim 1 further comprising:
determining a secondary script which converts the intermediate tree to the new tree using row major forms;
determining a secondary script which converts the intermediate tree to the new tree using column major forms; and
selecting the second partial script from the secondary scripts based on cost.

9. A method according to claim 1 wherein the data trees are rooted, ordered, labelled trees formed from data in a respective table.

10. A method according to claim 9 wherein the data trees contain only nodes having a degree of 0, 1, 2 and only nodes of degree 2 contain data from the respective table.

11. A method of updating data in a mobile communication terminal, comprising:
determining an old data table which exists in the device;
determining a new data table which is required in the device;
determining an edit script which converts the old data table to the new data table, transmitting the edit script to the device; and
actuating the device to implement the edit script, wherein the edit script is determined using a method as outlined above.

12. A system for creating an edit script for conversion of an old data table to a new data table, the system comprising:
a processor; and
a memory coupled to the processor to store instructions, which when executed from the memory, cause the processor to
create an old data tree and a new data tree from the old table and the new table respectively,
determine a first partial script which converts the old tree to an intermediate tree having the same length as the new tree, and
determine a second partial script which converts the intermediate tree to the new tree, and combining the first and second partial scripts.

13. A system according to claim 12 wherein the first partial script is determined as a minimum cost series of edits causing only insertions and deletions in the old data tree.

14. A system according to claim 13 wherein the first partial script inserts or deletes only complete sub-trees in the old data tree.

15. A system according to claim 12 wherein the second partial script is determined as a minimum cost series of edits causing only substitutions in the intermediate tree.

16. A system according to claim 12 wherein the first partial script is determined using an edit distance matrix with the old tree and the intermediate tree in row major form.

17. A method according to claim 12 wherein the second partial script is be determined using an edit distance matrix with the intermediate tree and the new tree in row major form.

18. A method according to claim 12 wherein the second partial script is determined using an edit distance matrix with the intermediate tree and the new tree in column major form.

19. A system according to claim 12 wherein the data trees are rooted, ordered, labelled trees formed from data in a respective table.

20. A system according to claim 9 wherein the data trees contain only nodes having a degree of 0, 1, 2 and only nodes of degree 2 contain data from the respective table.
